(19) United States
(12) Patent Application Publication
(10) Pub. No.: US 2025/0330033 A1
(43) Pub. Date: Oct. 23, 2025

(54) BATTERY MANAGEMENT SYSTEM WITH IN SITU CELL REJUVENATION

(71) Applicant: REON Technology, Inc., Chelmsford, MA (US)

(72) Inventors: Tiegeng Ren, Westford, MA (US); Xuanhang Zhang, Austin, TX (US)

(73) Assignee: REON Technology, Inc., Chelmsford, MA (US)

(21) Appl. No.: 19/254,096

(22) Filed: Jun. 30, 2025

Related U.S. Application Data
(63) Continuation-in-part of application No. 18/385,439, filed on Oct. 31, 2023.
(63) Continuation-in-part of application No. 18/137,471, filed on Apr. 21, 2023.
(63) Continuation-in-part of application No. 18/115,811, filed on Mar. 1, 2023.
(60) Provisional application No. 63/315,550, filed on Mar. 2, 2022.
(60) Provisional application No. 63/333,708, filed on Apr. 22, 2022.
(60) Provisional application No. 63/333,708, filed on Apr. 22, 2022.
(60) Provisional application No. 63/334,106, filed on Apr. 23, 2022.
(60) Provisional application No. 63/334,160, filed on Apr. 24, 2022.
(60) Provisional application No. 63/334,160, filed on Apr. 24, 2022.
(60) Provisional application No. 63/422,464, filed on Nov. 4, 2022.
(60) Provisional application No. 63/534,791, filed on Aug. 25, 2023.
(60) Provisional application No. 63/536,514, filed on Sep. 5, 2023.
(60) Provisional application No. 63/666,285, filed on Jul. 1, 2024.
(60) Provisional application No. 63/691,350, filed on Sep. 6, 2024.

(51) Int. Cl. H02J 7/00; H01M 10/052; H01M 10/42

(52) U.S. Cl. CPC H02J 7/0069; H01M 10/052; H01M 10/4257; H02J 7/0013; H02J 7/005; H02J 7/0063; H02J 7/00711; H01M 2010/4271; H01M 2010/4278

(57) ABSTRACT

A plurality of battery units is accessed. The battery units contain one or more battery cells. The plurality of battery units is configured by a master controller, using programmable switches. The master controller monitors battery cell health based on sensors within each of the battery units. The master controller determines a battery cell, within the plurality of battery units, requiring rejuvenation. The programmable switches are reconfigured to supply a rejuvenation current through the battery cell. The master controller configures the programmable switches to shape the rejuvenation current into a pulse train. The rejuvenating of the battery cell is accomplished in situ, based on a voltage, an amperage, a frequency, a duty cycle, and a duration of the rejuvenation current. The rejuvenating can be customized for each battery cell and adjusted based on additional monitoring.

### RELATED APPLICATIONS

This application claims the benefit of U.S. provisional patent applications “Battery Management System With In Situ Cell Rejuvenation” Ser. No. 63/666,285, filed Jul. 1, 2024 and “Integrated Solar And Battery Systems With Virtual Power Point Tracking” Ser. No. 63/691,350, filed Sep. 6, 2024.

This application is also a continuation-in-part of U.S. patent application “Software-Defined Energy Storage System Interface” Ser. No. 18/115,811, filed Mar. 1, 2023, which claims the benefit of U.S. provisional patent applications “Software-Defined Energy Storage System Interface” Ser. No. 63/334,106, filed Apr. 23, 2022, “Battery System Management Using Cell State” Ser. No. 63/333,708, filed Apr. 22, 2022, “Battery Performance Tracking Across Battery Cells” Ser. No. 63/334,160, filed Apr. 24, 2022, and “Dynamic Control Of A Disparate Battery System” Ser. No. 63/315,550, filed Mar. 2, 2022.

This application is also a continuation-in-part of U.S. patent application “Battery Performance Tracking Across Battery Cells” Ser. No. 18/137,471 filed Apr. 21, 2023, which claims the benefit of U.S. provisional patent applications “Battery System Management Using Cell State” Ser. No. 63/333,708, filed Apr. 22, 2022 and “Battery Performance Tracking Across Battery Cells” Ser. No. 63/334,160, filed Apr. 24, 2022.

This application is also a continuation-in-part of U.S. patent application “Battery Management System With Controlled Replacement” Ser. No. 18/385,439, filed Oct. 31, 2023, which claims the benefit of U.S. provisional patent applications “Battery Management System With Controlled Replacement” Ser. No. 63/422,464, filed Nov. 4, 2022, “Distributed Power System For Management And Control” Ser. No. 63/534,791, filed Aug. 25, 2023, and “Battery Management System With Low Latency” Ser. No. 63/536,514, filed Sep. 5, 2023

Each of the foregoing applications is hereby incorporated by reference in its entirety.

### FIELD OF ART

This application relates generally to battery management and more particularly to a battery management system with in situ cell rejuvenation.

### BACKGROUND

One of the greatest boons to humankind has been the discovery and harnessing of electricity. Prior to the late 1800s, mechanical work was achieved with wind, flowing water, steam, or the muscles of humans and domesticated animals. The amount of power that could be applied was limited to the degree to which people could generate and channel these natural elements. Even though static electricity had been observed hundreds of years before the common era, it was not until the 1600s that European scientists began to document and theorize about electricity. It was not until the early 1800s that the fundamentals of producing electricity emerged. Michael Faraday discovered that rotating a conductive disk or a loop of wire perpendicular to a static magnetic field could generate direct current electricity. This was the first version of a dynamo. Commercial production of electricity started with coupling dynamos to hydraulic turbines. This mechanical production of electric power started the second industrial revolution and led to a host of practical inventions throughout the late 1800s through the 1900s.

Direct current (DC) electricity was commercialized before alternating current (AC) electricity, mainly through the work of Thomas Edison and his colleagues at General Electric. Edison invented the first practical incandescent light bulb in 1879. However, alternating current (AC), championed by Nikola Tesla and George Westinghouse, soon became a strong competitor. AC power can more easily and efficiently be converted into higher or lower voltages. Edison, with his significant investment in DC production, argued that AC power was more dangerous. The issue was effectively settled when the 1893 Chicago World's Fair chose to power electric lights across the exhibition using Tesla's AC system. At first, delivering electricity to homes was done with little more than bare copper wrapped with minimal cotton insulation. Sockets, switch handles, and fuse blocks were made of wood. No voltage regulators were in place, so lights would dim and brighten based on the amount of demand on the electrical grid. Knob and tube wiring eventually gave way to flexible armored cabling, which offered more protection from wire damage. Later, electricians began to use metal conduit. Electric wiring was still more dangerous than it is today because the wiring was not grounded. This made the chance of electric shock or fire much more likely. It was not until 1965 that grounded wiring became the standard for household wiring. When combined with circuit fault interrupters and circuit breakers, the safety of electrical wiring has vastly improved.

As more electric appliances became available, the demand for electricity increased. Electric vacuum cleaners, refrigerators, washing machines, sewing machines, and so on led to nearly every home in the U.S. being supplied with electricity by 1960. Now, with the plethora of modern appliances and devices all requiring electricity, this power source is considered essential for modern life. And while the uses of electricity have continued to expand, our ability to produce electricity has developed more slowly. The first centralized power stations used steam engines to drive a dynamo to produce a DC current which powered public lighting in New York City. This model was copied by cities around the world as gas-fueled streetlights were converted to electric power. Soon after, public buildings and businesses added electric lights as well. In areas where natural resources were readily available, water power or steam was used to drive turbines to generate electricity. Coal, oil, wind, natural gas, or nuclear reactors are now used as well to drive massive turbines to supply the world's electricity needs. Solar energy, tidal power, and geothermal sources are also tapped to add to our growing demand for this valuable aid to humankind.

### SUMMARY

Many of the most popular rechargeable batteries use lithium, including lithium ion, lithium iron phosphate, and lithium-ion polymer batteries. Lithium batteries have high energy density, they charge quickly, they are relatively lightweight, they can operate in extreme temperatures, and they can be recharged many more times than other rechargeable battery types. However, they are more expensive than other rechargeable batteries, and they can degrade significantly when overcharged. Lithium batteries can also have serious safety concerns, including explosions in some cases. The reason for this is the formation of lithium dendrites during the recharging process. Lithium dendrites are small, rigid, tree-like structures that grow inside a lithium battery. These metallic microstructures form on the negative electrode during the charging process. Their needle-like projections are sometimes referred to as “whiskers.” Lithium dendrites and whiskers can cause significant harm by piercing the battery's separator, like a weed poking through a paved road or sidewalk. This can lead to unwanted chemical reactions between the electrolyte and the lithium within the battery, accelerating battery failure, which can result in catastrophic consequences.

Techniques for a battery management system (BMS) with in situ cell rejuvenation are disclosed. A plurality of battery units is accessed. The battery units contain one or more battery cells. The plurality of battery units is configured by a master controller using programmable switches. The master controller monitors battery cell health based on sensors within each of the battery units. The master controller determines a battery cell within the plurality of battery units requiring rejuvenation. The programmable switches are reconfigured to supply a rejuvenation current through the battery cell. The master controller configures the programmable switches to shape the rejuvenation current into a pulse train. The rejuvenating of the battery cell is accomplished in situ, based on a voltage, an amperage, a frequency, a duty cycle, and a duration of the rejuvenation current. The rejuvenating is customized for each battery cell and adjusted based on additional monitoring.

A processor-implemented method for battery management is disclosed comprising: accessing a plurality of battery units, wherein the battery units contain one or more battery cells, wherein the plurality of battery units is configured using programmable switches, and wherein the plurality of battery units is configured by a master controller; determining a battery cell within the plurality of battery units requiring rejuvenation; reconfiguring the programmable switches to supply a rejuvenation current through the battery cell; controlling the programmable switches to shape the rejuvenation current into a pulse train; and rejuvenating the battery cell in situ, based on a voltage, an amperage, a frequency, a duty cycle, and a duration of the rejuvenation current. In embodiments, the voltage, the amperage, the frequency, the duty cycle, and the duration are supervised by the master controller. Some embodiments comprise monitoring battery cell health within the plurality of battery units. In embodiments, the monitoring is performed by sensors within each of the plurality of battery units.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for battery management with in situ cell rejuvenation.

FIG. 2 is a flow diagram for battery cell rejuvenation adjustment.

FIG. 3 shows columns of battery cells and switches in a battery system.

FIG. 4 illustrates providing rejuvenation current to a battery cell.

FIG. 5 is a system block diagram for managing in situ cell rejuvenation.

FIG. 6 is a flow diagram for a battery system with cell rejuvenation controls.

FIG. 7 is a system block diagram for a battery management system with in situ cell rejuvenation.

FIG. 8 is a system diagram for a battery management system with in situ cell rejuvenation.

### DETAILED DESCRIPTION

Batteries have been used to generate electrical energy since the early 1800s. The first experimental batteries used stacked disks of copper and zinc separated by cloth soaked in salt water. The first practical application of a battery was called the Daniell cell, made from a copper pot filled with a copper sulfate solution, immersed in an earthenware container filled with sulfuric acid and a zinc electrode. Versions of this battery cell were used in telegraphs for many years. Different combinations of acids and metals were used to generate electric current with varying degrees of success. One major problem with the earliest batteries was that they could not be recharged. Once the metals and chemicals used to create the battery were expended, they had to be replaced with fresh metal plates and acid or salt solutions. Then, in 1859, the lead-acid battery was developed. A lead anode and a lead dioxide cathode immersed in sulfuric acid produce lead sulfate. The chemical reactions occurring at the anode and diode produce an electric current. These chemical reactions can be reversed by passing a reverse current through the battery, recharging it. Not only is this type of battery stable and rechargeable, it can also be mass produced relatively easily. Lead-acid batteries are still in use in automobiles and other applications today. Smaller and lighter rechargeable batteries are now made from combinations of electrode materials such as nickel and cadmium, zinc and oxygen, and nickel and metal hydride.

Lithium batteries show great promise in many applications requiring reliable, rechargeable energy sources. Uninterruptable power supply (UPS) and power backup systems, laptops, recreational vehicles, alarm systems, mobility systems, pacemakers, digital cameras, solar energy systems, and portable power packs are just a few of the systems in which lithium batteries have been used with considerable success. Lithium batteries require little or no maintenance, they charge quickly, they can store more energy in a smaller space than other rechargeable batteries, they are small, they are lightweight, and they have long lifespans. However, they are also susceptible to serious safety concerns. Lithium batteries can form dendrites within the battery case. Lithium dendrites are metallic microstructures that form on the negative electrode during the charging process. These needle-like projections can cause significant harm by piercing the battery's separator, leading to unwanted chemical reactions, and accelerating battery failure, sometimes catastrophically. These safety concerns have seriously impacted the use of lithium cells. Compounding the issue is the fact that it is very difficult to address dendrite growth while the affected cell is being used; the battery cell must typically be removed and sent to the manufacturer in order to recondition suspect or faulty batteries.

Techniques for a battery management system with in situ cell rejuvenation are disclosed. Sets of lithium battery cells are arranged into battery units. Depending on the overall power and physical size specifications, the number of battery cells per unit, as well as the total number of battery units, can vary. Each battery unit can include a local controller and sensors to monitor the performance of each cell, as well as the battery unit overall. A series of programmable switches is included in the battery system at various levels, allowing battery cells, battery units, and columns of battery units to be selected for recharging when necessary. A master controller is set over the entire battery system. The master controller receives battery performance data forwarded by the local controllers and compares it to performance standards stored in its cache memory. The master controller manages the various programmable switches, maintains consistent current to the load, and isolates reserve battery units for recharging. When sensor data forwarded by local controllers indicates that a battery unit is underperforming, the master controller sets the programmable switches to direct a recharging current to the one or more battery cells in need. When rejuvenation is required, the master controller manages the programmable switches to produce an “AC” pulse train to apply to the battery cell. The pulsed current can not only recharge the battery, but it can also rejuvenate it by healing existing dendrites and suppressing new dendrite formation. The entire rejuvenating charge process is accomplished by battery units within the battery system, in situ. No external maintenance or battery removal is required. Once the battery unit is rejuvenated, the master controller resets the programmable switches and the current flow continues uninterrupted. Since the number of battery units in the system can exceed the current requirements for a load, the current flow to the load can remain constant. The recharging process can be repeated whenever needed, with different columns of batteries exchanging roles as rejuvenation current providers to the rest of the system. The result is a safe and stable power source, recharging and managing itself. The battery system is versatile, allowing for multiple battery systems to be linked to one another and controlled by redundant master controllers when needed. The battery system can also be linked to an industrial internet of things (IIoT) network, allowing reprogramming of the master controller and the use of dozens of different battery system arrangements of voltage, amperage, frequency, and duty cycle production, depending on the type of battery, the present health of the battery, the history of the battery, and so on.

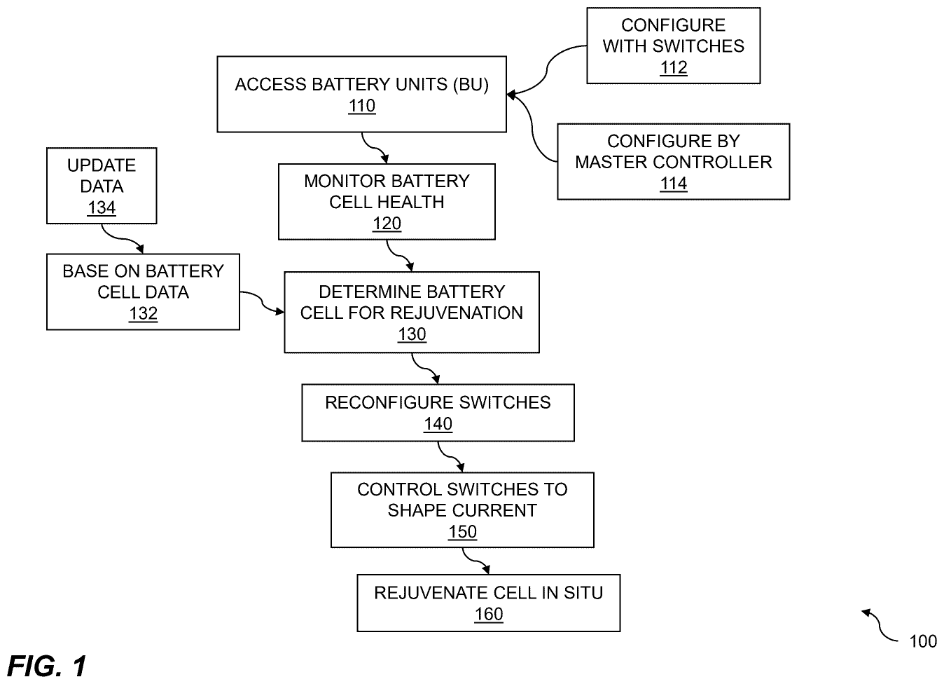

FIG. 1 is a flow diagram for battery management with in situ cell rejuvenation. The flow describes accessing a group of rechargeable lithium battery units (BUs), configured with programmable switches. The switches are controlled by a master controller and can be used to route power to a load, adjust load voltage and current, reconfigure the battery system for recharging, route a rejuvenation current to a battery cell or battery unit in need of rejuvenation, and so on. Sensors within each battery unit are used to monitor the health of each battery cell. Performance data recorded by the sensors flows through local controllers in the battery unit to the master controller. The battery performance data can be updated based on timing controlled by the master controller. The performance data can also be compared to predetermined configurations provided by external sources. When the master controller determines that a battery cell is in need of rejuvenation, it sets the programmable switches to route the rejuvenation current to the battery cell in need. The rejuvenation current can be provided by battery units within the overall battery system. In some cases, multiple battery systems can be linked together to provide additional capacity for both the load and recharge capabilities. Once the battery unit or battery cell to be recharged has been selected, and the switches are set to direct the rejuvenation current, the master controller manages the programmable switches to shape the rejuvenation current into an alternating current-like (AC) pulse train. The pulsed charge can recharge the battery cell, suppress the formation of lithium dendrites, and/or heal existing dendrites. The entire rejuvenation process is accomplished within the battery system itself. The battery units used to provide the rejuvenation current and the battery cells being recharged remain in situ. The sensors within the battery unit continue to monitor battery performance as it is recharged. Once the rejuvenation is complete, the master controller reconfigures the programmable switches, and the providing of power to the load proceeds uninterrupted.

The flow 100 includes accessing 110 a plurality of battery units. The battery units contain one or more battery cells within a single physical unit. By way of a simple example, a standard alkaline 9V battery is comprised of six 1.5V alkaline cells arranged in series. The 9V battery could be considered the switchable battery cell or unit that is disclosed herein, whereas each of the six cells comprising the 9V battery would be the aforementioned battery cell comprising six constituent cells. The battery units can include new rechargeable batteries. The battery units can include rechargeable batteries that have been removed from vehicles, energy storage devices, personal electronic devices, and so on. These batteries can be considered used, previously used, preowned, “second life,” etc. New and used battery cells can be combined in the battery management system. In embodiments, the one or more battery cells are comprised of lithium, including lithium-ion battery cells. Other types of rechargeable cells, such as lithium-polymer (LiPo) and lithium-iron-phosphate (LiFePO₄), can be included. The plurality of battery units is configured 112 using programmable switches. The battery units can be arranged in series, in parallel, or in a combination of series-parallel using the programmable switches. The battery units can comprise a battery column. Each battery column can be connected in parallel using the programmable switches. In embodiments, the plurality of battery units is configured 114 by a master controller. The voltage, the amperage, the frequency, the duty cycle, and the duration of the rejuvenation pulses are all controlled by the master controller working with multiple local controllers.

The flow 100 further comprises monitoring 120 battery cell health within the plurality of battery units. In embodiments, the monitoring is performed by sensors within each of the plurality of battery units. The sensors can be used to monitor battery performance information such as temperature, temperature rate-of-change, current, voltage, voltage rate-of-change, or impedance data. The sensors can collect battery performance information in situ and register the data in a cache included in the battery unit. The battery performance data can be sent to a system cache included in the master controller and can be compared to battery performance standards stored in one or more register maps. The master controller can analyze battery units to determine usability and capacity of the battery units.

The flow 100 includes determining 130 a battery cell, within the plurality of battery units, which requires rejuvenation. Battery rejuvenation is a process that restores a battery to a state close to its original condition, reversing or preventing degradation that can occur over time. In embodiments, the determining is based on the monitoring. The master controller can compare battery performance data collected by the sensors in the battery cells to battery data for the same battery cell type stored in one or more registers included in the master controller. In embodiments, the determining is based 132 on external characterization data for the one or more battery cells. A battery profile for each battery cell type can be created using external characterization data collected from battery manufacturers, distributors, or groups of users. The determining further comprises updating 134 the external characterization data, based on updated battery cell health data. As battery performance data is collected from the sensors included in the battery units, the battery cell profiles can be updated for each battery cell type. In embodiments, the updated battery cell health is obtained in situ. These profiles can be compared to battery performance data collected by the sensors and used to determine when a battery cell needs to be rejuvenated. In embodiments, the rejuvenating is based on the monitoring. Once a battery unit performance falls below an established threshold, the master controller can begin the process of rejuvenation of the one or more battery cells within the battery unit requiring recharging. In other embodiments, the rejuvenation determination is made based on battery type, battery history, battery manufacturing quality data, and so on, and it can be done on a predetermined and fixed schedule.

The flow 100 includes reconfiguring 140 the programmable switches to supply a rejuvenation current through the battery cell. The switches can be used in combination to isolate a battery cell from the remainder of battery cells in a battery column and direct a rejuvenation current to the selected battery cell. Switches can be used to allow a rejuvenation current to flow to a specific battery column. Switches can be used to bypass one or more battery cells within a column. Switches can be used to select a battery cell for receiving a rejuvenation current. All switches within the battery system can be configured by the master controller. The master controller can configure the programmable switches to provide the rejuvenation current to one or more battery cells simultaneously, based on the amount of rejuvenation current available and the most efficient method of charging the battery cells requiring rejuvenation. The management of programmable switches by the master controller allows the same wiring used to supply power to the load to be used to rejuvenate battery cells in situ without interrupting or altering the configuration of the power to the load.

The flow 100 includes controlling 150 the programmable switches to shape the rejuvenation current into a pulse train. A pulse train uses one or more switches that turn on and off to produce pulse charges for a battery. Pulse charging is a method of charging battery cells that involves alternating between high current pulses and low current or short relaxation periods. The charge used to rejuvenate battery cells within the battery units can come from one or more battery cells within the battery system. In embodiments, the rejuvenation occurs while the plurality of battery units is being charged by a current source external to the plurality of battery units. The external source can be one or more battery systems connected to the battery system containing battery cells to be rejuvenated. The use of more than one battery system can allow the current supply to the load to remain constant while rejuvenation of battery cells occurs. The master controller can use multiple switches within the battery system to shape the rejuvenation current flowing into a battery cell into a pulse train. In embodiments, the pulse train comprises a stepwise linear sine wave. AC electric current flows in a sine wave pattern, due to rapid control and constant reconfiguring of the multiple switches. In embodiments, the pulse train comprises a square wave. A square wave is a waveform in which the amplitude alternates at a steady frequency between fixed minimum and maximum values, with the same duration at minimum and maximum. In an ideal square wave, the transitions between the minimum and maximum values are instantaneous.

The flow 100 includes rejuvenating the battery cell in situ 160, based on a voltage, an amperage, a frequency, a duty cycle, and a duration of the rejuvenation current. The master controller can isolate the battery cell to be rejuvenated by configuring one or more switches included in the plurality of battery units. In embodiments, the rejuvenation occurs while the plurality of battery units is supplying load current to a load. In embodiments, the load can be external to the plurality of battery units. In embodiments, the load can be within the plurality of battery units. As noted above, the rejuvenation occurs while the plurality of battery units is being charged by a current source external to the plurality of battery units. The plurality of battery units can also be charged by current supplied by one or more battery units within the same battery system. As current flows from the battery units to the load, the master controller can simultaneously rejuvenate a battery cell or cells and supply current to a load by controlling battery system switch functionality within and among the cells and columns. The rejuvenating process can be accomplished using a pulse train.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

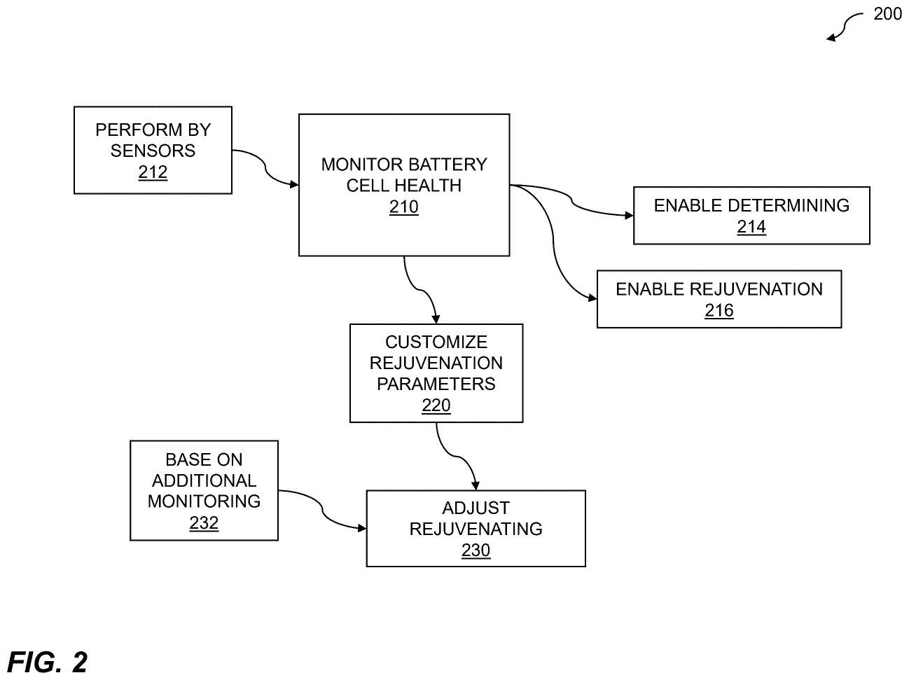

FIG. 2 flow diagram for battery cell rejuvenation adjustment. The flow 200 includes monitoring 210 battery cell health within the plurality of battery units. In embodiments, the monitoring is performed 212 by sensors within each of the plurality of battery units. The sensors can be used to monitor battery performance information such as temperature, temperature rate-of-change, current, voltage, voltage rate-of-change, or impedance data. The sensors can collect battery performance information in situ and register the data in a cache included in the battery unit. The battery unit can include a local controller that can forward battery performance information to the master controller. The local controller can turn current switches into and out of the battery cell off or on, allowing the battery cell to be coupled or decoupled from a battery unit. This allows a battery cell to be replaced or removed, when necessary, due to battery failure or end of life. The battery performance data can be sent to a system cache included in the master controller and compared to battery performance standards stored in one or more register maps. The master controller can analyze battery units to determine usability and capacity of the battery units. In embodiments, the voltage comprises a maximum voltage between 3V and 1000V. In embodiments, the amperage comprises a maximum amperage between 30 A and 150 A. In embodiments, the frequency comprises a maximum frequency between 0.5 Hz and 500 Hz. In embodiments, the duty cycle comprises an “on” percentage between 30% and 70%. In embodiments, the duration comprises a time between 1s and 100s.

In embodiments, the monitoring enables 214 the determining. The battery performance data supplied to the master controller can be used to analyze the battery units to determine usability and capacity. The usability and capacity data can be included in the battery profiles. The usability can include whether a battery unit is available for configuration in a battery system, whether the battery unit has physical integrity, etc. The capacity of a battery unit can include remaining capacity. The remaining capacity can be based on a percentage, a value, a threshold, and so on. The master controller can use the performance data to determine when a battery cell requires rejuvenating, based on comparing current performance data to predetermined performance data for each battery cell type. In embodiments, the monitoring enables 216 the rejuvenation. As the master controller analyzes the battery performance data, battery cells that fall below performance requirements can be configured for rejuvenation. Switches controlling current flow to the battery column, battery unit, and battery cell can be configured by the master controller to route a rejuvenation current to the one or more battery cells requiring it. The rejuvenation current can be sent to the battery cells in situ, while the battery cells within the battery unit continue to supply current to the load. In embodiments, the master controller can control the programmable switches to shape the rejuvenation current into a pulse train, allowing the battery cells to recharge without forming lithium dendrites.

In embodiments, the voltage, the amperage, the frequency, the duty cycle, and the duration are customized 220 for each battery cell in situ rejuvenation. Predefined battery configurations are stored and accessed by the master controller. The predefined configurations can specify the voltage, the amperage, the frequency, the duty cycle, and the duration required by the total load, as well as the profiles of each battery type included in the battery system. The master controller can configure the programmable switches to form one or more battery units and battery columns to supply the required load and to allow for rejuvenation of battery cells within the battery system when required. The master controller can customize the configuration of each battery cell within the battery system, based on the requirements of the total battery system and the capacities of each battery cell. As battery cells are recharged and rejuvenated over time, their performance changes. The flow 200 further comprises adjusting 230 the rejuvenating, based on additional monitoring 232. The local and master controller can continue to collect performance information on each battery cell within the battery system. The configuration of each battery type can be adjusted as performance data is collected and analyzed by the master controller. In embodiments, the updated battery cell health data is obtained through additional external characterization data. The battery system can be included in an industrial internet of things (IIoT) network. The IIOT can include data collection, exchange, and analysis using one or more computing devices. Computing systems included in the IIOT can supply additional analysis and performance data, expanding the capabilities of the master controller. Performance data can be collected from external sources such as suppliers, battery manufacturers, trade organizations, user groups, and so on. As internal and external data is compiled and analyzed, the life cycle and performance of battery cell types can be better predicted and managed to optimize each battery cell in the battery system.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

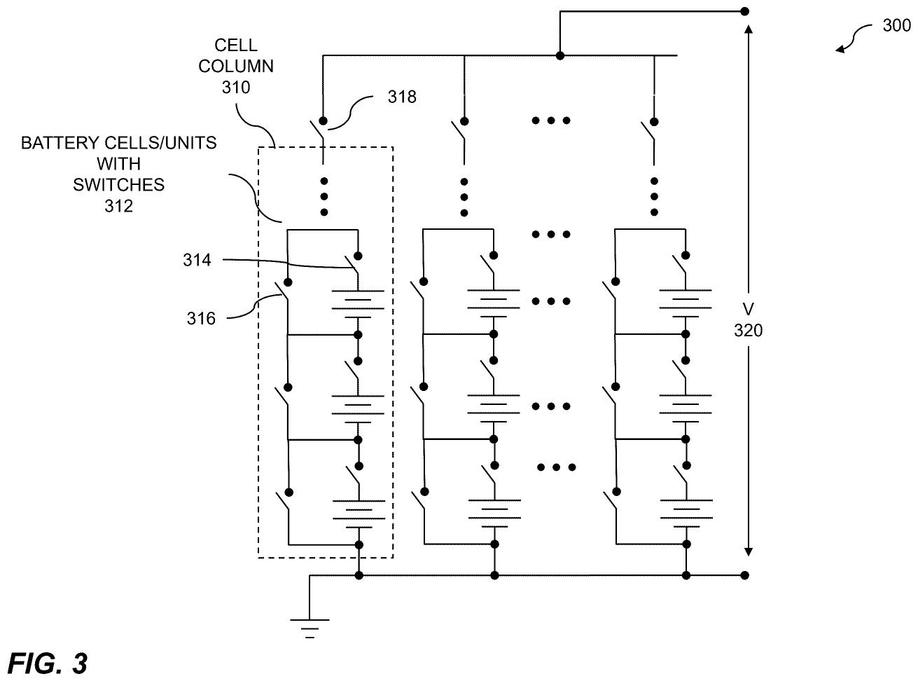

FIG. 3 shows columns of battery cells and switches in a battery system. The FIG. 300 includes a plurality of battery cells. In embodiments, the one or more battery cells are comprised of lithium. The lithium batteries can include lithium-ion battery cells. Other types of rechargeable cells, such as lithium-polymer (LiPo) and lithium-iron-phosphate (LiFePO₄), can be included. The battery cells can include new rechargeable batteries. The battery cells can include rechargeable batteries that have been removed from vehicles, energy storage devices, personal electronic devices, and so on. These batteries can be considered used, previously used, preowned, “second life,” etc. New and used battery cells can be combined in the battery units. The battery cells can be arranged in series using the programmable switches. The programmable switches can be used to combine battery cells into battery units. The plurality of battery units can be configured using programmable switches 314 and 316, which are repeated for each battery unit 312 (or cell) that comprises battery column 310. Each battery column can be connected in parallel using the programmable switches. Each column of battery units can be isolated using one or more programmable switches, such as switch 318. The example 300 shows all programmable switches open. More battery cells could be configured into each battery column. More battery columns could be added to the battery system. In the example 300, all battery cells, units, and columns are isolated and are not supplying power to a load, being recharged, or being rejuvenated.

In embodiments, the plurality of battery cells can be configured by a master controller. The voltage, the amperage, the frequency, the duty cycle, and the duration of each battery cell and battery column can be supervised by the master controller. The voltage can comprise a maximum voltage between 3V and 1000V. The amperage can comprise a maximum amperage between 30 A and 150 A. The frequency can comprise a maximum frequency between 0.5 Hz and 500 Hz. The duty cycle can comprise an “on” percentage between 30% and 70%. The duration can comprise a time between 1s and 100s. The master controller can configure the programmable switches to provide the required voltage 320 across the battery system so that the current supplied to the load does not sag or surge. The master controller can use battery columns within the battery system to recharge and rejuvenate in situ battery cells as needed in order to maintain the required voltage across the battery system.

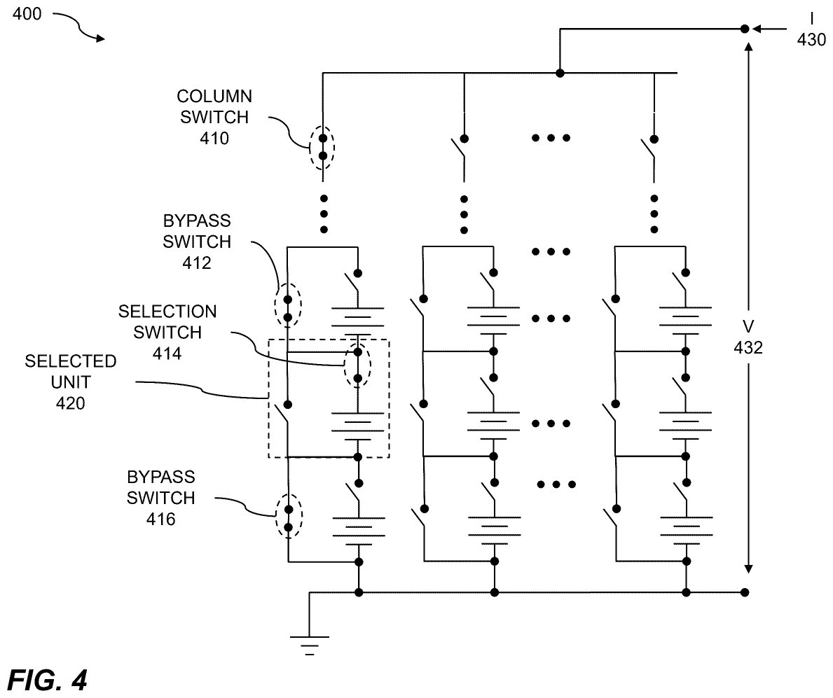

FIG. 4 illustrates providing rejuvenation current to a battery cell. In embodiments, the battery cells are composed of lithium. The lithium batteries can include lithium-ion battery cells. Other types of rechargeable cells, such as lithium-polymer (LiPo) and lithium-iron-phosphate (LiFePO₄), can be included. The battery cells can include new rechargeable batteries. The battery cells can be arranged in series using the programmable switches. The illustration 400 shows three sets of battery units (or cells) arranged in series in three columns, although additional battery units and battery columns are possible as indicated by the large horizontal and vertical ellipses throughout. Each battery column can be connected in parallel using the programmable switches. Each column of battery cells can be selected to receive a rejuvenation current 430 using a column switch 410. In the illustration 400, the selected unit 420 has been configured to receive the rejuvenation current. The column switch has been closed, allowing the rejuvenation current to flow into the column of battery cells. The bypass switch 412 has been closed, allowing the rejuvenation current to flow past the first cell in the column. The selection switch 414 has been closed, allowing the rejuvenation current to flow into the selected battery cell. The bypass switch for the selected cell is open, routing the rejuvenation current into the selected cell. The bypass switch 416 is closed, so that the next battery cell in the battery column does not receive the rejuvenation current. The voltage 432 supplied to the load is maintained by the master controller using other battery columns (not shown) while the rejuvenation of the selected battery cell continues. The rejuvenation current can be supplied from an external source, from another battery column or columns within the BMS, or even from battery units within the same column as the unit being rejuvenated.

The illustration 400 includes rejuvenating the battery cell in situ, based on a voltage, an amperage, a frequency, a duty cycle, and a duration of the rejuvenation current. In embodiments, the voltage, the amperage, the frequency, the duty cycle, and the duration are supervised by the master controller. A predefined configuration for the battery cell can be stored by the master controller and used to compare the performance of the battery cell to the predefined configuration. The master controller can continue to monitor the battery cell health of the battery cell receiving a rejuvenation current as the recharging proceeds. In embodiments, the monitoring is performed by sensors within each of the plurality of battery units. When the rejuvenation current charges the selected battery cell to meet the predefined configuration, the rejuvenation current can be discontinued by resetting the programmable switches, allowing the battery column to function as before.

In embodiments, the rejuvenation occurs while the plurality of battery units is supplying load current to a load. The load can be external to the plurality of battery units. The load can be within the plurality of battery units. In embodiments, the rejuvenation can occur while the plurality of battery units is being charged by a current source external to the plurality of battery units. The current source can be supplied by additional battery systems connected to the load as well as the battery system that includes battery cells requiring rejuvenation. The rejuvenation current can also be supplied by battery units or battery columns included in the same battery system containing the battery cells to be recharged. In embodiments, the master controller can shape the rejuvenation current into a pulse train as described above, whether the charge is supplied from within the same battery system or from another battery system.

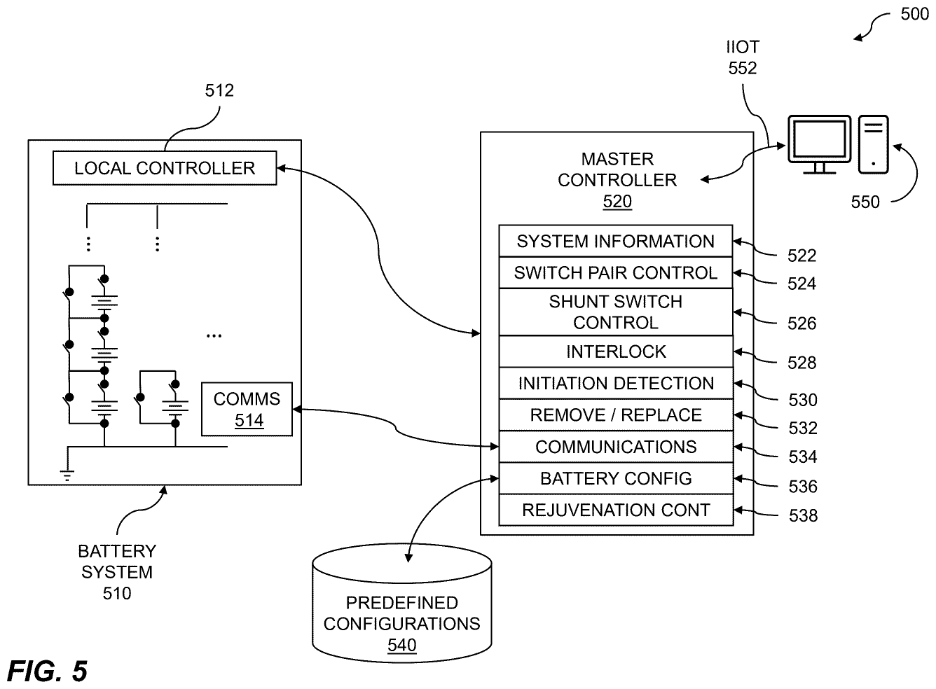

FIG. 5 is a system block diagram for managing in situ cell rejuvenation. The diagram 500 includes a battery system 510 comprised of a plurality of battery units. In embodiments, the battery system includes a local controller 512. The local controller can communicate with sensors included in each battery cell. The sensors can be used to monitor battery performance information such as temperature, temperature rate-of-change, current, voltage, voltage rate-of-change, or impedance data. The sensors can collect battery performance information in situ and register the data in a cache included in the battery unit. The local controller can use communications 514 included in the battery system to forward battery performance information to the master controller 520. The master controller can include communications 534 components to interact with the local controllers and with one or more systems 550 in an industrial internet of things (IIoT) 552. The local controller can turn current switches into and out of the battery cell off or on, allowing the battery cell to be coupled or decoupled from a battery unit. This allows a battery cell to be replaced or removed, when necessary, due to battery failure or end of life. The battery performance data can be sent to a system cache included in the master controller and compared to battery performance standards stored in one or more register maps. The master controller can analyze battery units to determine usability and capacity of the battery units.

In embodiments, the plurality of battery units within the battery system is configured by the master controller. The master controller can include system information 522. The system information can include the voltage, amperage, frequency, duty cycle, and the duration settings required by the load connected to the battery system. The system information can access predefined configurations 540 that can be used to configure 536 battery cells included in the battery system. The predefined configurations can include the voltage, amperage, frequency, duty cycle, and duration settings for each battery cell type included in the battery system.

The master controller can include one or more switch pair controllers 524. The switch pair controllers can be used in combination with one or more shunt switch controls 526 included in the master controller. The master controller can use the switch pair controllers and shunt switch controls to configure the battery cells into battery units and battery columns. The master controller can use the switch pair and shunt switch controls to route rejuvenation current to battery cells that require recharging. The master controller can use the switch pair and shunt switch controls to shape the rejuvenation current into a pulse train. Pulse charging is a method of charging that involves alternating between high current pulses and low current or short relaxation periods. It can help reduce charging time while maintaining cycle life and can also help mitigate degradation from fast charging. The charge used to rejuvenate battery cells within the battery units can come from one or more battery cells within the battery system. In embodiments, the pulse train comprises a stepwise linear sine wave. AC electric current flows in a sine wave pattern. The external current source can be an AC current that can be shaped into a stepwise linear sine wave by alternating between positive and negative voltage levels. In embodiments, the pulse train comprises a square wave. A square wave is a waveform in which the amplitude alternates at a steady frequency between fixed minimum and maximum values, with the same duration at minimum and maximum. A square wave or stepwise linear sine wave creates a rejuvenation current that switches from on to off and to on again, repeatedly. This alternating charging current energizes the selected battery cell and rejuvenates it at the same time.

The master controller can include an interlock system 528. The interlock can manage the current flow between the main circuit to the load and the current flowing to provide rejuvenation for battery cells. The interlock can prevent switch pairs that should not be turned on simultaneously from doing so. It is a safety system to ensure the proper functioning of the programmable switches and the correct amount of electrical power to flow through the battery system and to the load. The master controller can include initiation detection 530. When a battery cell is selected for rejuvenation, the initiation detection component can notify the master controller that the rejuvenation process has started. This confirms that the programmable switches have been correctly configured and that current is flowing to the selected battery cell. The master controller can include a remove/replace system 532. Batteries can come to an end-of-life status, be damaged, overheat, and so on. The local controllers and sensors can signal the master controller that a battery cell needs to be removed or replaced. The master controller can also track the performance of a battery cell and determine that it can no longer be recharged or has reached its end-of-life status. The remove/replace system can signal an operator or user of the IIoT network to replace the battery cell. The notification can identify the location of the battery cell within the battery system, including the battery cell type, reason for replacement, and so on. The remove/replace system can use the communications component included in the master controller to accomplish the notification. The master controller can include a rejuvenation controller 538. The rejuvenation controller can confirm that rejuvenation current is flowing to the selected battery cell; can monitor the voltage, the amperage, the frequency, the duty cycle, and the duration settings of the rejuvenation current; and can manage the programmable switches to shape the rejuvenation current into the pulse train. When the battery cell has been rejuvenated, the rejuvenation controller can notify the master controller so that the programmable switches can be reset to turn off the rejuvenation current and allow battery power to flow normally to the load.

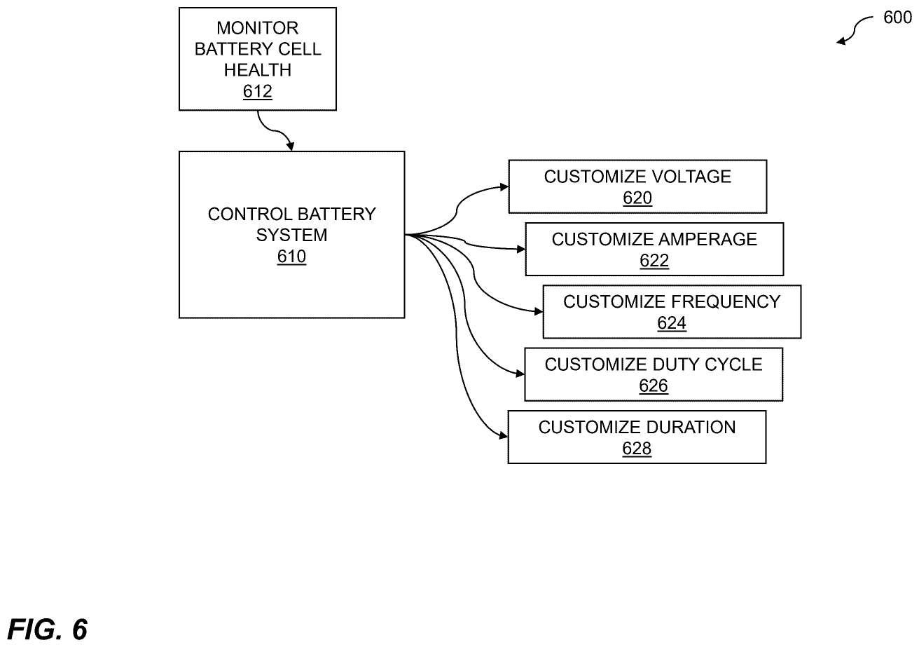

FIG. 6 is a flow diagram for a battery system with cell rejuvenation controls. The flow 600 includes controlling a battery system 610. In embodiments, the controlling can be accomplished by a master controller. The master controller can monitor battery health within the plurality of battery units. The master controller can configure programmable switches to manage current flow to the load. In embodiments, the voltage, the amperage, the frequency, the duty cycle, and the duration are supervised by the master controller. In embodiments, the master controller determines a battery cell included in a battery system requiring rejuvenation. The determining is based on the master controller monitoring battery cell health 612 within the plurality of battery units. In embodiments, the determining is based on the monitoring. The master controller can compare battery performance data collected by the sensors in the battery cells to battery data for the same battery cell type stored in one or more registers included in the master controller. In embodiments, the determining is based on external characterization data for the one or more battery cells. A battery profile for each battery cell type can be created using external characterization data collected from battery manufacturers, distributors, or groups of users. The determining further comprises updating the external characterization data, based on updated battery cell health data. As battery data is collected from the sensors included in the battery units, the battery cell profiles can be updated for each battery cell type. These profiles can be compared to battery performance data collected by the sensors and used to determine when a battery cell needs to be rejuvenated. Once a battery unit performance falls below an established threshold, the master controller can begin the process of rejuvenation of the one or more battery cells within the battery unit requiring recharging.

In embodiments, the master controller can rejuvenate the battery cell in situ, based on a voltage, an amperage, a frequency, a duty cycle, and a duration of the rejuvenation current. The rejuvenation current can be customized based on the current requirements of the load, the amount of current available in the battery system, the amount of current available in one or more battery systems that can be attached to the first battery system, and the capacity of the battery cell requiring rejuvenation. In embodiments, the voltage 620, the amperage 622, the frequency 624, the duty cycle 626, and the duration 628 are customized for each battery cell requiring in situ rejuvenation. Voltage is a measurement of the electromotive force or pressure between two points, for instance, between a battery system and a load circuit. In embodiments, the voltage can comprise a maximum voltage between 3V and 1000V. Amperage is a measurement of the current flow rate. In embodiments, the amperage can comprise a maximum amperage between 30 A and 150 A. Frequency is the rate at which an alternating current (AC) changes direction per second. In embodiments, the frequency can comprise a maximum frequency between 0.5 Hz and 500 Hz. A duty cycle is a ratio of time a waveform signal is on compared to off. For example, a waveform that is in the high state, or on, half of the time versus off has a 50% duty cycle. In embodiments, the duty cycle can comprise an “on” percentage between 30% and 70%. Duration is the amount of time that a rejuvenation current is applied to a cell to remove lithium dendrites and recharge the battery cell. The duration can comprise a time between 1s and 100s.

In embodiments, the controller can adjust the rejuvenating, based on additional monitoring. As battery cells are recharged and rejuvenated over time, their performance changes. The local controller in each battery unit and the master controllers can continue to collect performance information on each battery cell within the battery system. The configuration of each battery type can be adjusted as performance data is collected and analyzed by the master controller. The battery system can be included in an industrial internet of things (IIoT) network. The IIOT can include data collection, exchange, and analysis using one or more computing devices. Computing systems included in the IIoT can supply additional analysis and performance data, expanding the capabilities of the master controller. As performance data is compiled and analyzed, the life cycle and performance of battery cell types can be better predicted and managed so as to optimize the performance of each battery cell in the battery system.

Various steps in the flow 600 may be changed in order, repeated, omitted, or the like without departing from the disclosed concepts. Various embodiments of the flow 600 can be included in a computer program product embodied in a non-transitory computer readable medium that includes code executable by one or more processors.

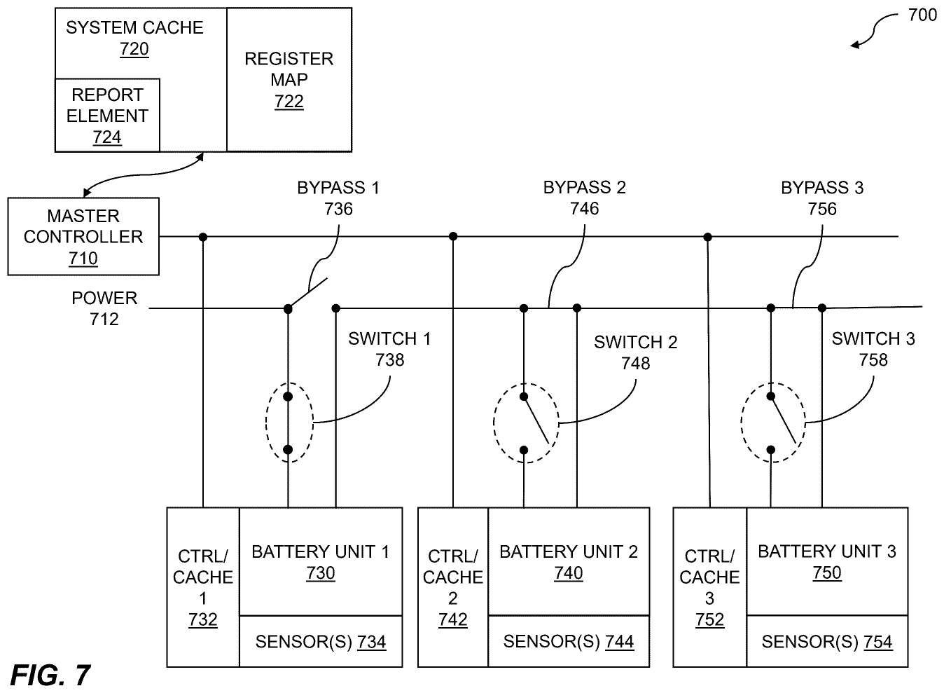

FIG. 7 is a system block diagram for a battery management system with in situ cell rejuvenation. The diagram 700 includes a master controller 710. In embodiments, the plurality of battery units is configured by the master controller. The configuration of the battery units can be accomplished by programmable switches managed by the master controller. In embodiments, the voltage, the amperage, the frequency, the duty cycle, and the duration are supervised by the master controller. Battery performance data can be sent to a system cache 720 included in the master controller and compared to battery performance standards stored in one or more register maps 722. The master controller can access one or more predetermined configurations for battery cells, battery units, and battery columns. The in situ performance measurements from the battery units can be compared to the performance standards to determine which battery units require rejuvenating. The master controller can analyze battery units to determine usability and capacity of the battery units. The master controller can include a report element 724. The report element can communicate with battery system operators and/or systems included in an IIOT network. The report element can include information on battery cell performance, battery cells needing removal or replacement, electrical statistics, rates of discharge, and so on.

The diagram 700 includes a plurality of battery units. In embodiments, the battery units contain one or more battery cells. The battery cells can include new rechargeable batteries. New and used battery cells can be combined in the battery units. In embodiments, the one or more battery cells are comprised of lithium, including lithium-ion battery cells. Other types of rechargeable cells, such as lithium-polymer (LiPo) and lithium-iron-phosphate (LiFePO₄), can be included. The battery units included in the diagram are battery unit 1 730, battery unit 2 740, and battery unit 3 750. Additional battery units can be included in battery system arrangements not shown in this diagram. Each battery unit can include one or more sensors that can monitor the voltage, amperage, and frequency of the battery unit. The sensors included in the diagram are sensor 734 for battery unit 1, sensor 744 for battery unit 2, and sensor 754 for battery unit 3. Each battery unit can include one or more controller caches which can be used to store sensor data and forward the data to the master controller. The controller caches included in the diagram are ctrl/cache 1 732 for battery unit 1, ctrl/cache 2 742 for battery unit 2, and ctrl/cache 3 752 for battery unit 3. The battery performance data collected by the sensors can be forwarded to the master controller based on a system clock managed by the master controller, by tokens, by carrier sense multiple access (CSMA), and so on.

In embodiments, the plurality of battery units is configured with programmable switches. In the diagram 700, two sets of switches are shown. A bypass switch is included in the power flow circuit to each battery unit. The power flow circuit can include a rejuvenation current. The bypass switch allows power 712 to flow to a load without flowing through a battery unit. The rejuvenation current can be provided by additional battery units within the battery system. The rejuvenation current can also be provided by one or more additional battery systems connected to the battery system shown in the diagram. In the diagram 700, bypass switch 1 736 is shown in the open position. When combined with closed switch 1 738, a rejuvenation current will pass into battery unit 1. Bypass switch 2 746 and bypass switch 3 756 are shown in the closed position. When combined with open switch 2 748 and open switch 3 758, a rejuvenation current cannot enter battery unit 2 or battery unit 3.

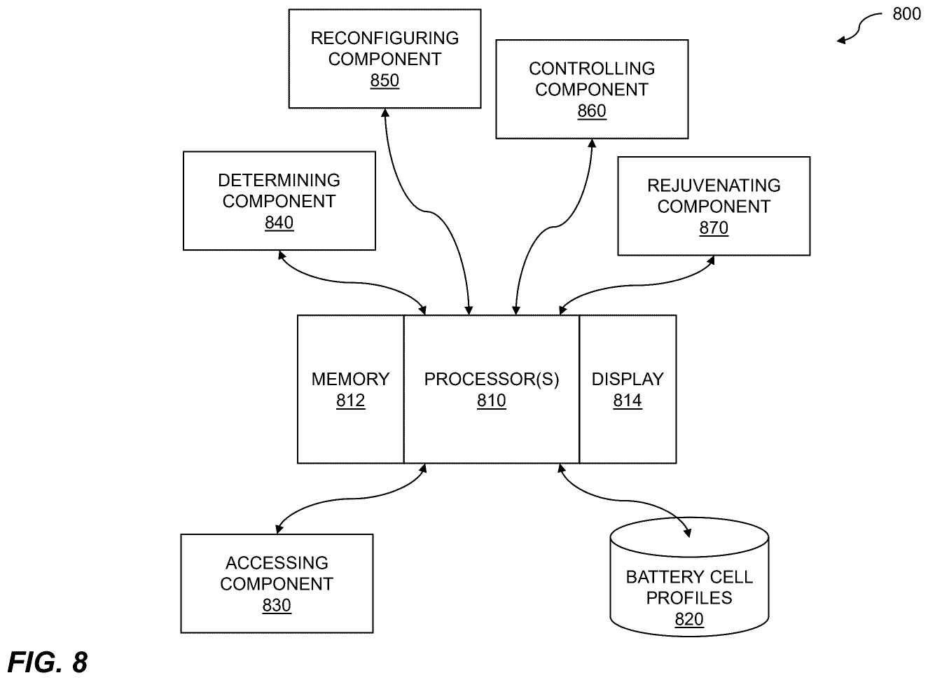

FIG. 8 is a system diagram for a battery management system with in situ cell rejuvenation. The system 800 can include one or more processors 810 coupled to a memory 812 which stores instructions. The system 800 can include a display 814 coupled to the one or more processors 810 for displaying data, intermediate steps, instructions, and so on. In embodiments, one or more processors 810 are coupled to the memory 812 where the one or more processors, when executing the instructions which are stored, are configured to: access a plurality of battery units, wherein the battery units contain one or more battery cells, wherein the plurality of battery units is configured using programmable switches, and wherein the plurality of battery units is configured by a master controller; determine a battery cell within the plurality of battery units requiring rejuvenation; reconfigure the programmable switches to supply a rejuvenation current through the battery cell; control the programmable switches to shape the rejuvenation current into a pulse train; and rejuvenate the battery cell in situ, based on a voltage, an amperage, a frequency, a duty cycle, and a duration of the rejuvenation current.

The system 800 includes battery cell profiles 820. The battery cell profiles 820 can include battery type, battery manufacturing lot data, battery age, battery usage, battery charge/discharge cycles, battery quality indications, battery charging requirements, battery rejuvenation requirements, and so on. The battery cell profiles 820 can be updated over time based on battery monitoring, battery manufacturing lot data updates, etc. The battery cell profiles can be used by the master controller to determine when a battery cell requires rejuvenation and to provide parameters for the rejuvenating process.

The system 800 includes an accessing component 830. The accessing component 830 can include functions and instructions for accessing a plurality of battery units, wherein the battery units contain one or more battery cells, wherein the plurality of battery units is configured using programmable switches, and wherein the plurality of battery units is configured by a master controller. The battery cells can include new rechargeable batteries. The battery cells can include rechargeable batteries that have been removed from vehicles, energy storage devices, personal electronic devices, and so on. These batteries can be considered used, previously used, preowned, “second life,” etc. New and used battery cells can be combined in the battery units. In embodiments, the one or more battery cells are comprised of lithium, including lithium-ion battery cells. Other types of rechargeable cells, such as lithium-polymer (LiPo) and lithium-iron-phosphate (LiFePO₄), can be included. The battery cells can be arranged in series using the programmable switches. The battery units can comprise a battery column. Each battery column can be connected in parallel using the programmable switches.

In embodiments, the configuring can further comprise monitoring battery cell health within the plurality of battery units. The monitoring can be performed by sensors within each of the plurality of battery units. The sensors can be used to monitor battery performance information such as temperature, temperature rate-of-change, current, voltage, voltage rate-of-change, or impedance data. The sensors can collect battery performance information in situ and can register the data in a cache included in the battery unit. The battery performance data can be sent to a system cache included in the master controller and compared to battery performance standards stored in one or more register maps. The master controller can analyze battery units to determine usability and capacity of the battery units.

The system 800 includes a determining component 840. The determining component 840 can include functions and instructions for determining a battery cell within the plurality of battery units requiring rejuvenation. In embodiments, the determining is based on the monitoring. The master controller can compare battery performance data collected by the sensors in the battery cells to battery data for the same battery cell type stored in one or more registers included in the master controller. In embodiments, the determining is based on external characterization data for the one or more battery cells. A battery profile for each battery cell type can be created using external characterization data collected from battery manufacturers, distributors, or groups of users. The determining further comprises updating the external characterization data, based on updated battery cell health data. As battery performance data is collected from the sensors included in the battery units, the battery cell profiles can be updated for each battery cell type. In embodiments, the updated battery cell health is obtained in situ. These profiles can be compared to battery performance data collected by the sensors and used to determine when a battery cell needs to be rejuvenated. In embodiments, the rejuvenating is based on the monitoring. Once a battery unit performance falls below an established threshold, the master controller can begin the process of rejuvenation of the one or more battery cells within the battery unit requiring recharging.

The system 800 includes a reconfiguring component 850. The reconfiguring component 850 can include functions and instructions for reconfiguring the programmable switches to supply a rejuvenation current through the battery cell. The programmable switches can be used to direct a rejuvenation current to the selected battery cell. Switches can be used to allow a rejuvenation current to flow to a specific battery column. Switches can be used to bypass one or more battery cells within a column. Switches can be used to select a battery cell for receiving a rejuvenation current. All switches within the battery system can be configured by the master controller. The master controller can configure the programmable switches to provide the rejuvenation current to one or more battery cells simultaneously, based on the amount of rejuvenation current available and the most efficient method of charging the battery cells requiring rejuvenation. The management of programmable switches by the master controller allows the same wiring used to supply power to the load to be used to rejuvenate battery cells in situ without interrupting or altering the configuration of the power to the load.

The system 800 includes a controlling component 860. The controlling component 860 can include functions and instructions for controlling the programmable switches to shape the rejuvenation current into a pulse train. A pulse train uses one or more switches that turn on and off to produce pulse charges for a battery. It can help reduce charging time while maintaining cycle life and can also help mitigate dendrite formation. The charge used to rejuvenate battery cells within the battery units can come from one or more battery cells within the battery system. In embodiments, the rejuvenation occurs while the plurality of battery units is being charged by a current source external to the plurality of battery units. The external source can be one or more battery systems connected to the battery system containing battery cells to be rejuvenated. The use of more than one battery system can allow the current supply to the load to remain constant while rejuvenation of battery cells occurs. The master controller can use multiple switches within the battery system to shape the rejuvenation current flowing into a battery cell into a pulse train. In embodiments, the pulse train comprises a stepwise linear sine wave. In embodiments, the pulse train comprises a square wave. A square wave or stepwise linear sine wave creates a charging current that switches from on to off to on again, repeatedly. This alternating charging current energizes the selected battery cell and rejuvenates it at the same time.

The system 800 includes a rejuvenating component 870. The rejuvenating component 870 can include functions and instructions for rejuvenating the battery cell in situ, based on a voltage, an amperage, a frequency, a duty cycle, and a duration of the rejuvenation current. The voltage, the amperage, the frequency, the duty cycle, and the duration of the rejuvenation current can be tailored for a particular battery unit or cell being rejuvenated. The master controller can isolate the battery cell to be rejuvenated by configuring one or more switches included in the plurality of battery units. In embodiments, the rejuvenation occurs while the plurality of battery units is supplying load current to a load. In embodiments, the load can be external to the plurality of battery units. In embodiments, the load can be within the plurality of battery units. As noted above, the rejuvenation occurs while the plurality of battery units is being charged by a current source external to the plurality of battery units. The plurality of battery units can also be charged by current supplied by one or more battery units within the same battery system. As current flows from the battery units to the load, the master controller can be rejuvenating battery cells that have been depleted simultaneously. The charging and rejuvenating process can be accomplished using a pulse train, so that the lithium batteries are not damaged by dendrite formation. This allows the batteries to remain in service for a longer period of time, lowering the number and frequency of replacements.

In embodiments, the rejuvenation addresses lithium dendrite growth. Lithium batteries are subject to the formation of dendrites during the recharging process. Lithium dendrites are small, rigid, tree-like structures that grow inside a lithium battery. They can form on the negative electrode during the charging process. Similar to ice forming in freezing water, the dendrites do not form in a uniform pattern or direction. Their needle-like projections are sometimes referred to as “whiskers.” Lithium dendrites and whiskers can cause significant harm by piercing the battery's separator, like a weed might poke through a concrete patio or a paved road. Pulse charging can suppress dendrite formation in lithium metal batteries. When lithium ions are charged with pulsed rather than continuous current, they have more time to diffuse before reacting with the electrode surface. This results in a more uniform distribution of lithium ions and thus, little or no dendrite formation. Pulse charging can additionally “heal” dendrites that have already formed by effectively removing the dendritic structure itself from lithium-based batteries.

The system 800 can include a computer program product embodied in a non-transitory computer readable medium for battery management, the computer program product comprising code which causes one or more processors to perform operations of: accessing a plurality of battery units, wherein the battery units contain one or more battery cells, wherein the plurality of battery units is configured using programmable switches, and wherein the plurality of battery units is configured by a master controller; determining a battery cell within the plurality of battery units requiring rejuvenation; reconfiguring the programmable switches to supply a rejuvenation current through the battery cell; controlling the programmable switches to shape the rejuvenation current into a pulse train; and rejuvenating the battery cell in situ, based on a voltage, an amperage, a frequency, a duty cycle, and a duration of the rejuvenation current.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for battery management comprising:
accessing a plurality of battery units, wherein the battery units contain one or more battery cells, wherein the plurality of battery units is configured using programmable switches, and wherein the plurality of battery units is configured by a master controller;
determining a battery cell within the plurality of battery units requiring rejuvenation;
reconfiguring the programmable switches to supply a rejuvenation current through the battery cell;
controlling the programmable switches to shape the rejuvenation current into a pulse train; and
rejuvenating the battery cell in situ, based on a voltage, an amperage, a frequency, a duty cycle, and a duration of the rejuvenation current.

2. The method of claim 1 wherein the voltage, the amperage, the frequency, the duty cycle, and the duration are supervised by the master controller.

3. The method of claim 1 further comprising monitoring battery cell health within the plurality of battery units.

4. The method of claim 3 wherein the monitoring is performed by sensors within each of the plurality of battery units.

5. The method of claim 3 wherein the determining is based on the monitoring.

6. The method of claim 3 wherein the rejuvenating is based on the monitoring.

7. The method of claim 3 wherein the voltage, the amperage, the frequency, the duty cycle, and the duration are customized for each battery cell in situ rejuvenation.

8. The method of claim 3 further comprising adjusting the rejuvenating, based on additional monitoring.

9. The method of claim 1 wherein the determining is based on external characterization data for the one or more battery cells.

10. The method of claim 9 further comprising updating the external characterization data, based on updated battery cell health data.

11. The method of claim 10 wherein the updated battery cell health data is obtained in situ.

12. The method of claim 10 wherein the updated battery cell health data is obtained through additional external characterization data.

13. The method of claim 1 wherein the rejuvenation occurs while the plurality of battery units is supplying load current to a load.

14. The method of claim 13 wherein the load is external to the plurality of battery units.

15. The method of claim 13 wherein the load is within the plurality of battery units.

16. The method of claim 1 wherein the rejuvenation occurs while the plurality of battery units is being charged by a current source external to the plurality of battery units.

17. The method of claim 1 wherein the pulse train comprises a square wave.

18. The method of claim 1 wherein the pulse train comprises a stepwise linear sine wave.

19. The method of claim 1 wherein the one or more battery cells are comprised of lithium.

20. The method of claim 19 wherein the rejuvenation addresses lithium dendrite growth.

21. A computer program product embodied in a non-transitory computer readable medium for battery management, the computer program product comprising code which causes one or more processors to perform operations of:
accessing a plurality of battery units, wherein the battery units contain one or more battery cells, wherein the plurality of battery units is configured using programmable switches, and wherein the plurality of battery units is configured by a master controller;
determining a battery cell within the plurality of battery units requiring rejuvenation;
reconfiguring the programmable switches to supply a rejuvenation current through the battery cell;
controlling the programmable switches to shape the rejuvenation current into a pulse train; and
rejuvenating the battery cell in situ, based on a voltage, an amperage, a frequency, a duty cycle, and a duration of the rejuvenation current.

22. A computer system for battery management comprising:
a memory which stores instructions;
one or more processors coupled to the memory, wherein the one or more processors, when executing the instructions which are stored, are configured to:
access a plurality of battery units, wherein the battery units contain one or more battery cells, wherein the plurality of battery units is configured using programmable switches, and wherein the plurality of battery units is configured by a master controller;
determine a battery cell within the plurality of battery units requiring rejuvenation;
reconfigure the programmable switches to supply a rejuvenation current through the battery cell;
control the programmable switches to shape the rejuvenation current into a pulse train; and
rejuvenate the battery cell in situ, based on a voltage, an amperage, a frequency, a duty cycle, and a duration of the rejuvenation current.
